(19) United States
(12) Patent Application Publication
(10) Pub. No.: US 2010/0307603 A1
(43) Pub. Date: Dec. 9, 2010

(54) Gas Pump with Limiting Pressure Feature

(75) Inventors: Ming Ki Gordon Au, Hong Kong (CN); Chuen Hung Eddie Fung, Hong Kong (CN); Kwok Leung NG, Hong Kong (CN); Kim Chuen B. John Leung, Hong Kong (CN)

Correspondence Address: REED SMITH LLP, 2500 ONE LIBERTY PLACE, 1650 MARKET STREET, PHILADELPHIA, PA, 19103, US

(73) Assignee: The Marketing Store Worldwide, LP, Lombard, IL (US)

(21) Appl. No.: 12/791,107

(22) Filed: Jun. 1, 2010

Related U.S. Application Data
(60) Provisional application No. 61/183,811, filed on Jun. 3, 2009.

(51) Int. Cl. F17D 1/00

(52) U.S. Cl. 137/14; 137/565.17

(57) ABSTRACT

A method and apparatus for pressurizing a fillable-structure, wherein a space defined by the pump, an untraversed plunger, and a closure is a volume, Vₜ, and a stop to limit the travel of the plunger along the pump so a volume, V_{b}, remains within the space defined by the pump, the fully traversed plunger, and the closure. Traversal or manipulation of the plunger expresses gas from the pump to the Tillable-structure wherein the pressurization of the fillable-structure is limited by the ratio of Vₜ to V_{b} whereby the fillable-structure can not be pressurized beyond a pressure Pₘₐₓ.

### FIELD

The present invention relates to a gas pump comprising a stop mechanism wherein the stop mechanism limits the amount of pressure that can be inserted into a volume to be filled by a predetermined value. The present invention may be used to pump air, or other gasses, into structures such as inflatable toys, balloons, mattresses, rafts, and toys or other structures of fixed volume finable by a gas.

### BACKGROUND

The embodiments of the present invention described herein are directed towards a need that has not been addressed by previous implementations of air or gas pumps. Previous types of pumps do not adequately address scenarios where over-pumping can occur by an operator of a gas pump. Over-pumping may occur where the operator is unaware of the pressure at which a structure being filled with a gas will reach the upper limit of its structural integrity and rupture. Further, each relevant structure having a compartment fellable by a gas will vary in its tensile strength and ability to withstand pressure without rupturing. Alternatively, even where a structure does not rupture, its structural integrity may become so degraded by the pressure forces exerted upon it that it is no longer safe to use or may no longer have the ability to effectively serve its intended purpose.

Alternatively, it may be desirable to only have a specified limited pressurization in a fillable volume for a given purpose, in excess of which would be undesirable.

Accordingly, it is desirable to have a gas pump which will not allow the pump operator, or actuator, to cause over-pumping of a fillable structure. The present invention, disclosed herein, provides an efficient, cost-effective means for limiting the pressure that can be inserted into a volume to be filled by a predetermined value. Inflatable structures contemplated by this invention include, but are not limited to, inflatable toys, balloons, mattresses, rafts, and toys or other structures of fixed volume.

### SUMMARY OF THE INVENTION

A method and apparatus for pumping gas into a fillable structure is provided featuring a pressure limiting feature, wherein the pump, a closure sealing a first opening of the pump at a first end having a one-way valve allowing only the egress of gas from the pump into a volume to be filled, a second opening on the pump at the opposite end, a plunger sealing the second opening and configured to slide along or traverse the pump and thereby express gas from the pump through the one-way valve, wherein a space defined by the pump, the fully traversed plunger, and the closure is a volume, Vₜ, and a stop to limit the travel of the plunger along the container so a volume, V_{b}, remains within the space defined by the container, the plunger, and the closure and the pressurization of the volume to be filled is limited by the ratio of Vₜ to V_{b} and the volume to be filled can not be pressurized beyond a pressure, Pₘₐₓ.

### DRAWINGS

While the accompanying claims set forth features of an apparatus and method for limiting pressure as disclosed herein with particularity, embodiments of the device and method may be best understood from the following detailed description taken in conjunction with the accompanying drawings, of which:

FIG. 1 illustrates a sectional view of a gas pump as exists in the prior art.

FIG. 2 illustrates a sectional view of a pump with a limited pressure feature, as disclosed herein.

FIG. 3 illustrates a sectional view of a pump with a limited pressure feature, as disclosed herein, wherein the stop is comprised of a separation between two chambers of the pump.

### DETAILED DESCRIPTION OF THE INVENTION

The present invention claims priority from United States Provisional Patent Application Ser. No. 61/183,811, filed Jun. 3, 2009, the contents of which are incorporated herein in their entirety by reference thereto.

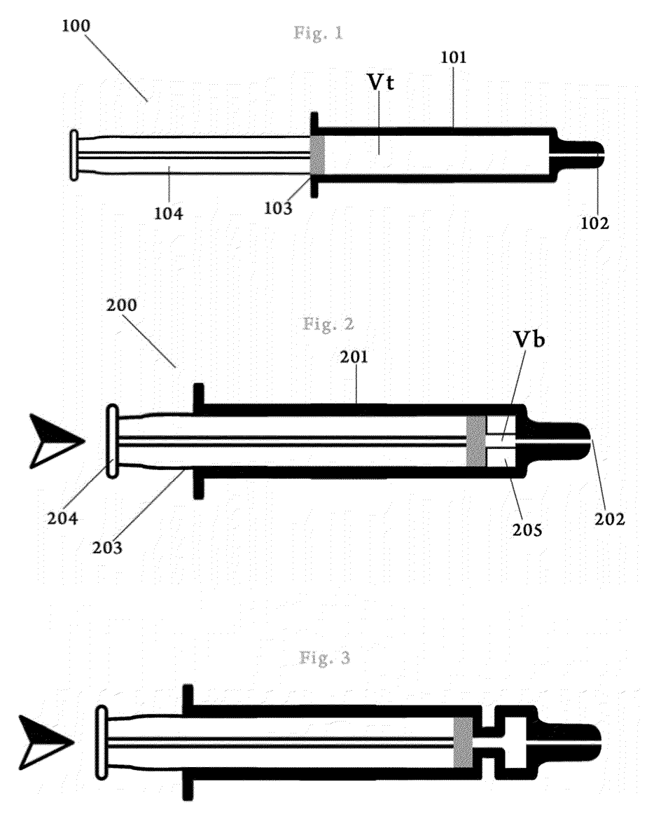

FIG. 1 is a sectional view of a gas pump 100 as existing in the prior art. The apparatus comprises a pump 101 having a long axis and enclosing a volume of gas, Vₜ. A first opening 102 on said pump 101 is located at the first end of the long axis wherein said first opening 102 includes a one-way valve for the egress of gas from said pump 101 into a volume to be inflated. A second opening 103 is located on the opposite end of said pump 101. A plunger 104 sealing said second opening 103 is configured to slide along the long axis of the pump 101. The gas having volume Vₜ may be expressed from the pump through the one-way valve located at the first opening 102. Upon full traversal of the plunger 104 along the long axis of the pump 101, all the gas in volume Vₜ is expressed through the one-way valve located at the first opening 102. The target fillable structure substantially receives all of the gas expressed from the pump 101.

In instances where the gas pump 100 has a third opening located on the long axis of the pump 101, the third opening may have a one-way valve which allows the ingress of gas to said pump 101. As the operator, or actuator, retracts the plunger 104, the pump 101 having volume Vₜ fills again with gas. The source of the gas may be atmospheric, an external gas container, a compressor, or any other relevant means of providing gas thereto. The plunger 104 may then be manipulated again to express the entirety of the gas into the target finable structure.

All possible target fillable structures have a maximum pressure value, Pₘₐₓ. Pₘₐₓ may be a function of the tensile strength of the materials comprising the Tillable structure. If a fillable structure attains an internal pressure beyond Pₘₐₓ, then the structure may rupture. Even where the structure does not rupture, its structural integrity may become so degraded by the pressure forces exerted upon it that it no longer is either safe to use or may no longer have the ability to effectively serve its intended purpose. Alternatively, it may be desirable to have a limited amount of pressure in a fillable structure, where pressure in excess of the stated amount is undesirable.

Accordingly, over repeated manipulations of the plunger 104, or even a single manipulation, the target fillable structure may attain an internal pressure which is in excess of the ideal pressure, Pₘₐₓ, recommended for that particular structure. Theoretically, through over-pumping, the internal pressure of the gas inside the finable structure can approach infinity. As stated, over-pumping may lead to rupturing of the fillable structure or, alternatively, conditions which are dangerous or negatively impact the utility of the fillable structure. This result is undesirable.

As disclosed in FIG. 2, the present invention improves upon the prior art and solves the problems caused by over-pumping by implementing a stop 205 to create a buffer zone having a volume V_{b}. In a preferred embodiment, the stop 205 is a ribbing or molding extruding from a fixed location on the interior of the pump 201. However, the stop 205 may be comprised of any suitable means capable of limiting the travel distance of the plunger 204. In a first alternative embodiment, the stop 205 is a post. In a second alternative embodiment, the stop 205 comprises a separation of two chambers of the pump 201. In a further alternative embodiment, the stop 205 may be slidable along the long axis of the pump 201 through an adjustment means accessible to the operator, or actuator, to achieve an ideal allocation of volume V_{b}.

The stop 205 operates to limit the distance along the long axis of the pump 201 that the plunger 204 can travel. The buffer zone is the volume of gas present in between the location of the stop 205, across which the plunger 204 cannot travel, and the first opening 202. Whereupon the plunger 204 has fully traversed the long axis of the pump 201, the gas comprising volume Vₜ, less volume V_{b}, may be expressed into the target finable structure.

The stop 205 must be located at an ideal position within the pump 201 in view of Pₘₐₓ. The ideal location of the stop 205 (i.e. the necessary volume of the buffer zone, V_{b}) may be determined by the following equation:

V_{b}=(VₜP₀)/Pₘₐₓ

The above equation assumes an ideal system, wherein no heat transfers to or from the environment of the pump and its components occurs. In the above equation, V_{b} is the desired volume of the buffer zone to be determined; Vₜ is the total volume of the pump 201; P₀ is the initial pressure of the gas within volume Vₜ; and Pₘₐₓ is the maximum pressure, or ideal pressure, of the target fillable structure, dependent upon the specifications and intended use of the structure. Accordingly, the stop 205 is positioned along the long axis, adjacent to the first opening as offset by volume V_{b} of the pump 201. If, however, it is desirable to have an operator, or actuator, perform multiple manipulations of the plunger 204, then the position of stop 205 may be adjusted accordingly, preserving the ratio between Vₜ and V_{b}. Furthermore, where practical considerations of scale between the pump 201 and the target fillable structure require, the ratio between Vₜ and V_{b} may be adjusted accordingly.

Manipulation of the plunger 204 may cause several different scenarios. The first instance is the “initial state,” the target fillable structure having a maximum pressure value of Pₘₐₓ, contains no gas and the plunger 204 has not yet been manipulated. Manipulation of the plunger 204 will result in the entirety of the gas comprising volume Vₜ, less the volume comprising volume V_{b}, to be expressed to the target finable structure. However, if the pressure of the gas within the target fillable structure is equal to or greater than Pₘₐₓ during manipulation or traversal of the plunger 204, or upon full manipulation or traversal of the plunger 204, then the pressure within volume V_{b} will equal Pₘₐₓ and no further gas will be expressed into the fillable structure. Accordingly, the present invention limits the pressure of the gas in the fillable structure to not exceed maximum compressed air pressure, or Pₘₐₓ, by the ratio of the total volume of the pump, Vₜ, to the volume of the buffering zone, V_{b}.

In a second instance, a gas is already present in the target fillable structure and the pressure of the gas within the structure has not yet exceeded Pₘₐₓ. Here, the operator, or actuator, may continue to pump until the pressure of the target fillable structure equals Pₘₐₓ, whereupon further pumping will not be possible, as described above. Accordingly, the problem in the prior art of possible over-pumping is addressed by the present invention.

It should be appreciated by those of skill in the art that the configuration and shape of the pump 201 may take several forms, including, but not limited to, a hand-pump, a foot-pump, a box-pump, a circular pump, or an oval pump. Accordingly, pumps envisioned by the present invention may not have a long axis. Further, a pump may be constructed of any suitable rigid or flexible material. In instances where a flexible material is used, the plunger may be the actual structure of the pump being compressed or traversed. Accordingly, it is to be appreciated that the embodiments discussed are exemplary and not limiting in the construction of the invention disclosed herein.

What is claimed is:

1. An apparatus for the pressurization of a container with a gas comprising:
a pump;
a closure sealing a first opening on the pump at a first end having a one-way valve allowing only the egress of gas from the pump into the container;
a second opening on the pump at the opposite end;
a plunger sealing the second opening of the pump and configured to slide from the opposite end of the pump towards the closure and thereby express the gas from the pump through the one-way valve into the container, wherein a space defined by the pump, the uncompressed plunger, and the closure is a volume, Vₜ; and
a stop to limit the travel of the plunger along the pump so a volume, V_{b}, remains within the space defined by the pump, the fully traversed plunger, and the closure.

2. The apparatus according to claim 1, wherein the stop is a rib inside the pump.

3. The apparatus according to claim 1, wherein the stop is a post inside the pump.

4. The apparatus according to claim 1, wherein the stop is comprised of a separation between two chambers of the pump.

5. The apparatus according to claim 1, where Vₜ/V_{b}>1.0.

6. The apparatus according to claim 1, where Vₜ/V_{b} is between 0.5 and 2.0.

7. The apparatus according to claim 1, where Vₜ/V_{b} is equal to 1.0.

8. The apparatus according to claim 1, where Vₜ/V_{b} is between 2.0 and 4.0.

9. The apparatus according to claim 1, wherein a third opening on the pump is located on the exterior perimeter of the pump having a one-way valve allowing only the ingress of gas to the pump.

10. The apparatus according to claim 1, wherein the container is a fixed volume.

11. The apparatus according to claim 1, wherein the container is an inflatable volume.

12. A method for pressurizing a container comprising the steps of:
providing a container to be pressurized up to a pressure, Pₘₐₓ;
providing a pump, the pump having a closure at a first opening on the pump at a first end having a one-way valve allowing only the egress of gas from the pump into the container and a second opening on the pump at the opposite end;
sliding the plunger along the pump and thereby expressing gas from the pump through the one-way valve, wherein the space defined by the pump, the uncompressed plunger, and the first opening is a volume, Vₜ, and wherein traversal of the plunger along the pump to pressurize the container is limited by a stop such that a volume, V_{b}, remains within the space defined by the pump, the fully traversed plunger and the closure and the pressurization of the container is limited by the ratio of Vₜ to V_{b} whereby the container can not be pressurized beyond a pressure, Pₘₐₓ.

13. The method of claim 12, wherein the stop is a rib inside the pump.

14. The method of claim 12, wherein the stop is a post inside the pump.

15. The method of claim 12, wherein the stop is comprised of a separation between two chambers of the pump.

16. The method of claim 12, where Vₜ/V_{b}>1.0.

17. The method of claim 12, where Vₜ/V_{b} is between 0.5 and 2.0.

18. The method of claim 12, where Vₜ/V_{b} is equal to 1.0.

19. The method of claim 12, where Vₜ/V_{b} is between 2.0 and 4.0.

20. The method of claim 12, wherein a third opening on the pump is located on the exterior perimeter of the pump having a one-way valve allowing only the ingress of gas to the pump.

21. The method of claim 12, wherein the container is a fixed volume.

22. The method of claim 12, wherein the container is an inflatable volume.

23. A method for pressurizing a container comprising the steps of:
providing a container of fixed volume to be pressurized up to a pressure, Pₘₐₓ;
providing a pump having a, the pump having a closure at a first opening on the pump at a first end having a one-way valve allowing only the egress of gas from the pump into the container and a second opening on the pump at the opposite end;
sliding the plunger along the pump and thereby expressing gas from the pump through the one-way valve, wherein the space defined by the pump, the uncompressed plunger, and the first opening is a volume, Vₜ, and wherein traversal of the plunger along the pump to pressurize the container is limited by a stop such that a volume, V_{b}, remains within the space defined by the pump, the fully traversed plunger and the closure and the pressurization of the container is limited by the ratio of Vₜ to V_{b} whereby the container can not be pressurized beyond a pressure, Pₘₐₓ.

24. The method of claim 23, wherein the stop is a rib.

25. The method of claim 23, wherein the stop is a post inside the pump.

26. The method of claim 23, wherein the stop is comprised of a separation between two chambers of the pump.

27. The method of claim 23, where Vₜ/V_{b}>1.0.

28. The method of claim 23, where Vₜ/V_{b} is between 0.5 and 2.0.

29. The method of claim 23, where Vₜ/V_{b} is equal to 1.0.

30. The method of claim 23, where Vₜ/V_{b} is between 2.0 and 4.0.

31. The method of claim 23, wherein a third opening on the pump is located on the exterior perimeter of the pump having a one-way valve allowing only the ingress of gas to the pump.
